(19) United States
(12) Patent Application Publication
(10) Pub. No.: US 2026/0010380 A1
(43) Pub. Date: Jan. 8, 2026

(54) OPERATING SYSTEMS CONFIGURED FOR CREATING AND LOADING A STORAGE HIGH AVAILABILITY SOLUTION CONFIGURATION

(71) Applicant: INTERNATIONAL BUSINESS MACHINES CORPORATION, ARMONK, NY (US)

(72) Inventors: TABOR R. POWELSON, POUGHKEEPSIE, NY (US); NICOLAS MARC CLAYTON, WARRINGTON (GB); SCOTT B. COMPTON, HYDE PARK, NY (US); DALE F. RIEDY, POUGHKEEPSIE, NY (US)

(21) Appl. No.: 18/762,977

(22) Filed: Jul. 3, 2024

(51) Int. Cl. G06F 9/445

(52) U.S. Cl. CPC G06F 9/44505

(57) ABSTRACT

Methods, systems, and products for automatically creating and loading a storage high availability solution configuration includes starting, by an operating system, a storage high availability solution address space; determining, for each device coupled to the operating system, whether the device is part of a device pair as a primary device that has a secondary pair and, if so, adding the device to a list of devices configured for a storage high availability solution, where the list of devices is included in a storage high availability solution configuration; and loading, by the operating system and based on the list of devices including at least one device, the storage high availability solution configuration.

### BACKGROUND

### Field of the Disclosure

The field of the disclosure is data processing, or, more specifically, methods and systems for automatically creating and loading a storage high availability solution (SHAS) configuration.

### Description of Related Art

Conventionally, normal processing of a SHAS requires that the replication manager server must build the SHAS configuration and send it to the operating systems managing the customer data. In cloud or multi-tenant environments, there could be a single management data plane managing the infrastructure for multiple customers. For privacy and independence among each customer, there is a need to separate the management data plane from the customer data plane. With the replication manager server managing the infrastructure, and the operating system managing customer data, conventional methods for operating SHAS do not have the operating system creating a SHAS configuration without communication from the replication manager server, and instead have the replication manager build, load, and run the SHAS configuration.

### SUMMARY

Methods, apparatus, and systems for automatically creating and loading a storage high availability solution configuration according to various embodiments are disclosed in this specification. In accordance with one aspect of the present disclosure, a method of automatically creating and loading a storage high availability solution configuration includes starting, by an operating system, a storage high availability solution address space; determining, for each device coupled to the operating system, whether the device is part of a device pair as a primary device that has a secondary pair and, if so, adding the device to a list of devices configured for a storage high availability solution, where the list of devices is included in a storage high availability solution configuration; and loading, by the operating system and based on the list of devices including at least one device, the storage high availability solution configuration.

In accordance with another aspect of the present disclosure, a system for automatically creating and loading a storage high availability solution configuration may include a replication manager server, a group of computing systems, where each computing system comprises an operating system, a first volume group having multiple volumes and communicatively coupled to the group of computing systems, and a second volume group communicatively coupled to the group of computing systems and separate from the first volume group, where the second volume group is a copy of the first volume group.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows an example line drawing of a system configured for automatically creating and loading a storage high availability solution configuration in accordance with embodiments of the present disclosure.

FIG. 2 is a block diagram of an example computing environment configured for automatically creating and loading a storage high availability solution configuration according to some embodiments of the present disclosure.

FIG. 3 is a flowchart of an example method for automatically creating and loading a storage high availability solution configuration according to some embodiments of the present disclosure.

FIG. 4 is a flowchart of an example method for automatically enabling a storage high availability solution according to some embodiments of the present disclosure.

FIG. 5 is a flowchart of another example method for automatically enabling a storage high availability solution according to some embodiments of the present disclosure.

### DETAILED DESCRIPTION

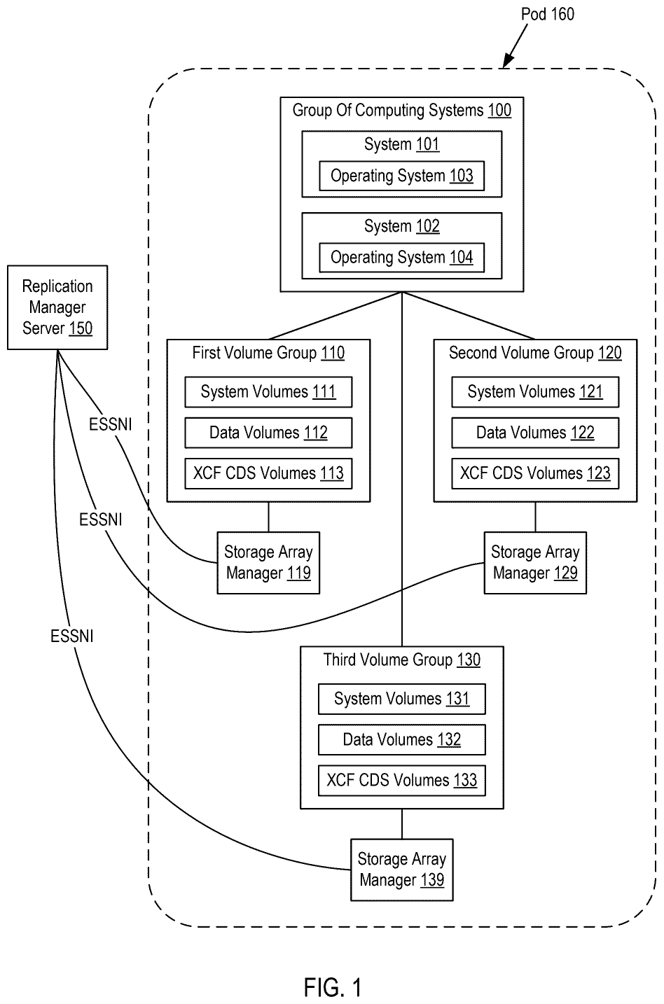

Exemplary methods, systems, and products for automatically creating and loading a storage high availability solution configuration in accordance with the present disclosure are described with reference to the accompanying drawings, beginning with FIG. 1. FIG. 1 sets forth an example line drawing of a system configured for automatically creating and loading a storage high availability solution configuration in accordance with embodiments of the present disclosure. The example of FIG. 1 includes a replication manager server 150, a group of computing systems 100, a first volume group 110, a second volume group 120, and a third volume group 130.

The group of computing systems 100, the first volume group 110, the second volume group 120, and the third volume group 130 are included within a pod 160. The pod 160 comprises systems and data for a given customer. In the example of FIG. 1, there is only a single pod. In other embodiments, there may be multiple pods connected with the replication manager server 150, with each pod comprising systems and volume groups for a separate customer.

The example group of systems 100 includes two or more systems (such as system 101 and system 102 in FIG. 1), and each system includes an operating system (such as operating system 103 and operating system 104). In the example of FIG. 1, each operating system is included on a separate system. In another embodiment, each operating system is implemented on a separate logical partition (LPAR), where each LPAR may be included on a single server or on separate servers. The example first volume group 110 is communicatively coupled to the group of computing systems 100 and includes one or more system volumes 111, one or more customer data volumes 112, and one or more Cross System Coupling Facility (XCF) managed couple dataset (CDS) volumes 113. The first volume group 110 may also include system logger couple dataset (LOGR CDS) volumes (not shown in FIG. 1). The first volume group 110 is managed by storage array manager 119. Storage array manager 119 may comprise any array manager, such as a DS8000 or the like.

The example second volume group 120 is communicatively coupled to the group of computing systems 100 and is separate from the first volume group 110. The second volume group 120 is managed by storage array manager 129. Storage array manager 129 may comprise any array manager, such as a DS8000 or the like. The second volume group 120 is a copy of the first volume group 110, and a plurality of the volumes included within the second volume group 120 are in a Peer to Peer Remote Copy (PPRC) relationship with the volumes of the first volume group 110 (such as each of the one or more system volumes 121, the one or more customer data volumes 122, and any LOGR CDS volumes (not shown in FIG. 1)). In contrast to the SHAS managed system volumes and data volumes, the one or more XCF managed CDS volumes 123 are only in subchannel set 0 and are not in a PPRC relationship with one another across volumes, as the CDS volumes are XCF managed instead of PPRC managed. Secondary pair volumes (such as the volumes in the second volume group 120) in a PPRC relationship (with their corresponding primary volumes, such as those in the first volume group 110) are duplicate copies of their corresponding primary volumes and are kept up to date and duplicated by the replication manager server 150.

The example third volume group 130 is communicatively coupled to the group of computing systems 100 and is separate from the first volume group 110 and the second volume group 120. While the third volume group 130 is included in FIG. 1, the third volume group is optional. That is, SHAS may still occur using only the first and second volume groups. The third volume group 130 is managed by storage array manager 139. Storage array manager 139 may comprise any array manager, such as a DS8000 or the like. The third volume group 130 is another copy of the first volume group 110 (for additional replication redundancy after the second volume group). For example, third volume group 130 includes a plurality of volumes that are in a PPRC relationship with the volumes of the first volume group 110 (such as each of the one or more system volumes 131, the one or more customer data volumes 132, and any LOGR CDS volumes (not shown in FIG. 1)). In contrast, the one or more XCF managed CDS volumes 133 are not in a PPRC relationship with one another across volumes, as the CDS volumes are XCF managed instead of PPRC managed. Tertiary pair volumes (such as the volumes in the third volume group 130) in a PPRC relationship (with their corresponding primary volumes, such as those in the first volume group 110) are duplicate copies of their corresponding primary volumes and are kept up to date and duplicated by the replication manager server 150.

The example replication manager server 150 is configured to communicate with the storage array managers of each volume group. However, the replication manager server 150 is not configured to communicate with the volume groups themselves, the data, or even any of the group of computing systems 100 or their included operating systems. In such an embodiment, the replication manager server is kept completely separate from the customer data plane for security purposes (such as if a single replication manager server manages multiple pods 160 each having different customer's data. The replication manager server 150 is configured to communicate over the ESSNI (Enterprise Storage Server Network Interface) to the storage array managers (such as 119, 129, and 139 in FIG. 1) to manage PPRC replication as part of the infrastructure plane, but does not interact with the data plane containing the user's systems and data.

SHAS (also known as a failover management product) is a function provided by the operating system. An example of SHAS include IBM's HyperSwap. SHAS provides continuous availability for disk failures by maintaining synchronous copies of all primary disk volumes on one or more secondary storage controllers. When a disk failure is detected, code in the operating system identifies SHAS-managed volumes and instead of failing the I/O request, as would be done before SHAS, instead switches (or swaps) information in internal control blocks so that the I/O request is driven against the synchronous copy. Because the secondary volume is an identical copy of the primary volume prior to the failure, the I/O request will succeed with no impact to the issuing program. Such an embodiment masks the disk failure from the program and avoids an application and system outage.

The list of disk volume pairs to be managed by SHAS are designated by the SHAS configuration. When a given volume pair is included within the SHAS configuration, the volume pair will be swapped in the event of a swap event. A swap event is triggered by any event that would cause an I/O request to fail. For example, a loss of access to the primary volume triggers a swap event.

Conventionally, normal processing of a SHAS requires that the replication manager server 150 must build the SHAS configuration and send it to the operating systems within the group of computing systems 100. In cloud or multi-tenant environments, there could be one management data plane managing the infrastructure for multiple customers. For privacy and independence among each customer, there is a need to separate the management data plane from the customer data plane. With the replication manager server 150 managing the infrastructure, and the operating system (such as 103 or 104) managing customer data, conventional methods for operating SHAS do not have the operating system creating a SHAS configuration without communication from the replication manager server 150. Accordingly, the embodiments of the present disclosure provide for a method of discovering and building a SHAS configuration solely within the operating system, which in turn allows the separation of the management data plane from the customer data plane.

One example embodiment of the present disclosure provides a method of automatically discovering and building a SHAS configuration, avoiding the need to have an external server (such as the replication manager server 150) build the SHAS configuration. The SHAS uses a SHAS Management Address space, which runs on every system in the group of computing systems 100, and is responsible for validating, maintaining, and monitoring the SHAS configuration, which requires a knowledge of every copy-set pair in the swap configuration. A PPRC primary and secondary device may either have different device numbers (e.g. aaaa and bbbb), or may use alternate subchannel set special secondary support (0aaaa and xaaaa, where x is the subchannel set number 1-3, corresponding to the first, second, and third volume groups). When a swap event occurs and the device fails over to the secondary device, the primary can change to the secondary and the secondary may become the primary. When alternate subchannel sets are used, each primary device will be in the active subchannel set, and its corresponding secondary device will be in the alternate subchannel set. A primary device is said to be paired with a device in the alternate subchannel set if they have the same device number, indicating they are connected to each other.

In one example embodiment, the system (such as a system within the group of computing systems) can tell which devices are intended to be in the swap configuration based on the I/O configuration, and only those which have corresponding alternate subchannel set pairs will be included within the SHAS configuration (i.e. will be set up to be SHAS managed). When the SHAS Management Address space is started and the discovery processing is requested, an I/O Supervisor (IOS) included within the operating system will scan for all devices in the system that are paired together using alternate subchannel set support, and will load those devices into the SHAS configuration. Because the I/O supervisor of the operating system has no communication with the replication manager server 150, it cannot tell if the replication manager server 150 has started PPRC mirroring and whether all pairs have transitioned to become fully duplicated. The I/O supervisor accounts for this by keeping the SHAS session disabled until it can validate that all device pairs have become fully duplicated (where the secondary devices are up-to-date replicas of the primary devices). That is, because the operating system cannot communicate with the replication manager server, the SHAS configuration is loaded before all pairs are fully duplicated, and the loaded SHAS configuration is indicated as not ready for enabling until all pairs are fully duplicated. Once all PPRC pairs have become fully duplicated, the I/O supervisor enables SHAS and can manage the SHAS configuration normally.

The operating environment depicted in FIG. 1 within one logical environment group (or “pod” 160), representing the data for one customer. One or more LPARs (logical partitions) or systems (such as system 101 and 102) are configured to host the customer's data and applications, within the scope of one group of computing systems 100. Internally, the system manages disk volumes in two (or three) volume groups: the primary copy on site 1 (first volume group 110), the secondary copy on site 2 (second volume group 120), an optional tertiary copy on site 3 (third volume group 130). That is, each volume group may be located at a different physical site or location. Having a primary and secondary copy allows for redundancy and storage high availability. The optional third copy also allows for resiliency to be maintained even in case of a storage system failure.

Within each volume group, a SHAS-managed device group contains: system volumes (such as the SYSRES and volumes containing paging datasets and parmlibs), data volumes containing the customer's data, and the System Logger couple dataset volumes. The I/O supervisor uses the alternate subchannel set to contain the secondary copy of the SHAS managed volumes, designating the device numbers in subchannel set 1. Similarly, a non-SHAS managed set of volumes (in each volume group) contains the XCF CDS and are only in subchannel set 0.

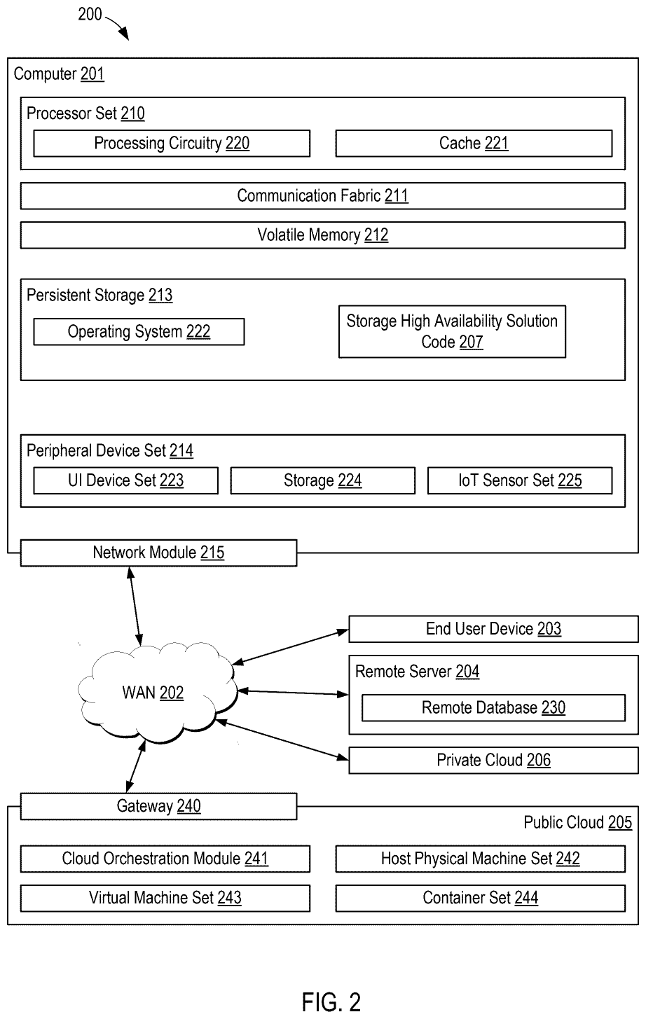

For further explanation, FIG. 2 sets forth a block diagram of computing environment 200 configured for automatically creating and loading a storage high availability solution configuration in accordance with embodiments of the present disclosure. Computing environment 200 contains an example of an environment for the execution of at least some of the computer code involved in performing the inventive methods, such as storage high availability solution code 207. In addition to storage high availability solution code 207, computing environment 200 includes, for example, computer 201, wide area network (WAN) 202, end user device (EUD) 203, remote server 204, public cloud 205, and private cloud 206. In this example embodiment, computer 201 is a system in the group of computing systems 100 of FIG. 1, and includes processor set 210 (including processing circuitry 220 and cache 221), communication fabric 211, volatile memory 212, persistent storage 213 (including operating system 222 and storage high availability solution code 207, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in storage high availability solution code 207 in persistent storage 213.

Communication fabric 211 is the signal conduction path that allows the various components of computer 201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in storage high availability solution code 207 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215. Network module 215 may be configured to communicate with other systems or devices, such as sensors 225, for receiving sensor measurements.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

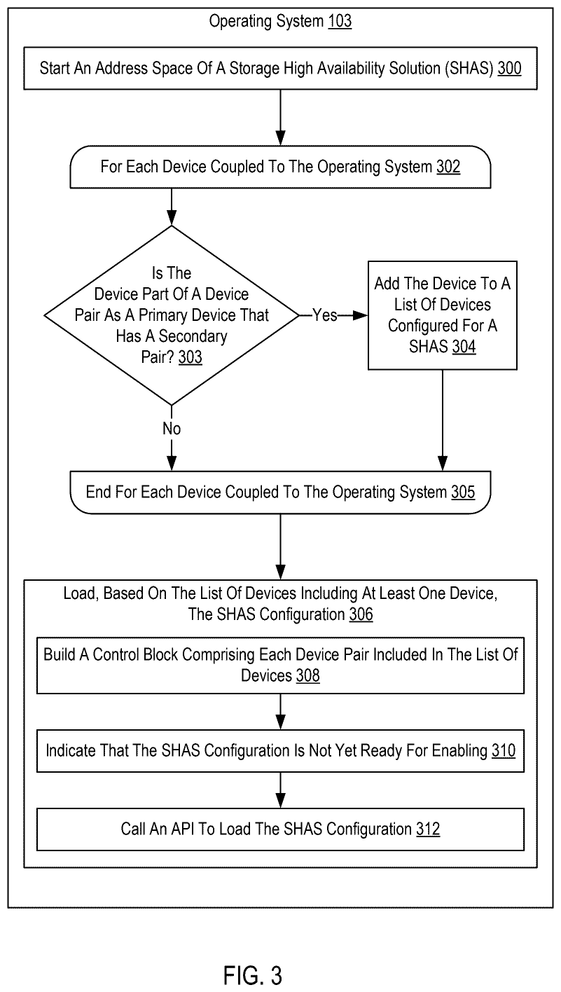

For further explanation, FIG. 3 sets forth a flow chart illustrating an exemplary method of automatically creating and loading a storage high availability solution configuration according to embodiments of the present disclosure. The method of FIG. 3 includes starting 300 an address space of a storage high availability solution (SHAS). Starting 300 an address space of a SHAS may be carried out by an operating system (such as operating system 103) by starting new processing for discovery of the configuration. After completing normal address space initialization, the operating system is configured to check if auto-discover of the configuration has been requested. For example, an auto-discover option may be selected (such as in PARMLIB (parameter libraries)). If selected, the operating system is configured (as described below) to loop through each device in the system using a service such as UCBSCAN.

The method of FIG. 3 also includes, for each device coupled to the operating system (see steps 302 through 305 in FIG. 3), determining 303 whether the device is part of a device pair as a primary device that has a secondary pair and, if so, adding 304 the device to a list of devices configured for a SHAS. In one embodiment, the list of devices is included in a SHAS configuration. Determining 303 whether the device is part of a device pair as a primary device that has a secondary pair may be carried out by an operating system (such as operating system 103). In FIG. 1, an example of a device pair is system volumes 111 (primary) and system volumes 121 (secondary), which has an alternate subchannel set grouping than the primary.

The method of FIG. 3 also includes loading 306, based on the list of devices including at least one device, the SHAS configuration. Loading 306 the SHAS configuration may be carried out by an operating system (such as operating system 103) by building 308 a control block comprising each device pair included in the list of devices. Building 308 a control block comprising each device pair included in the list of devices may be carried out by an operating system (such as operating system 103) by saving the swap-from and swap-to device Node Element Descriptor information for every device pair from the list of devices.

The method of FIG. 3 also includes, as part of loading 306 the SHAS configuration, indicating 310 that the SHAS configuration is not yet ready for enabling. Indicating 310 that the SHAS configuration is not yet ready for enabling may be carried out by an operating system (such as operating system 103) by setting a flag associated with the SHAS configuration indicating that the SHAS configuration is not ready to be enabled.

The method of FIG. 3 also includes, as part of loading 306 the SHAS configuration, calling 312 an API (application programming interface) to load the SHAS configuration. Calling 312 an API to load the SHAS configuration may be carried out by an operating system (such as operating system 103) sending an instruction to the interface to load the configuration.

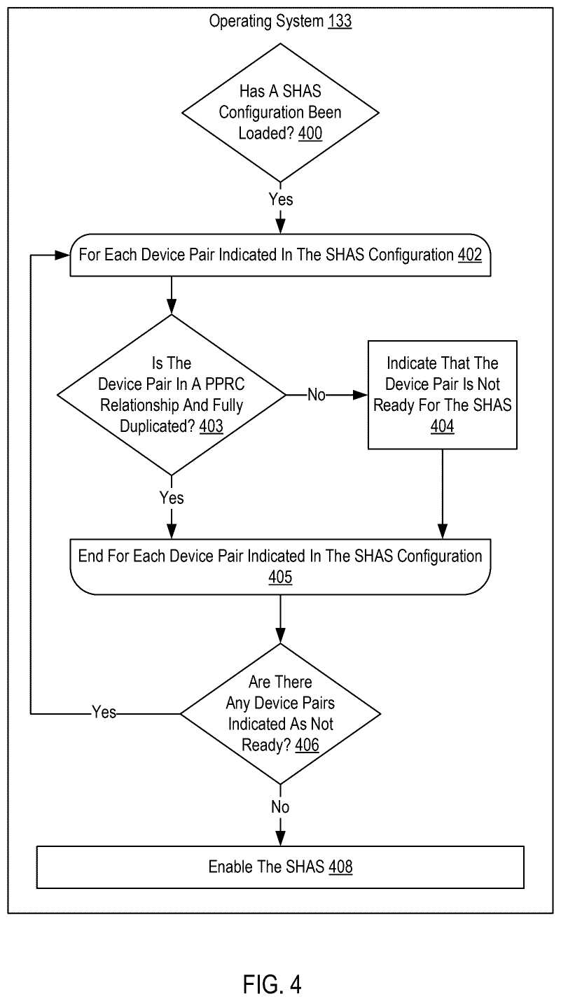

For further explanation, FIG. 4 sets forth a flow chart illustrating another exemplary method of automatically creating and loading a storage high availability solution configuration according to embodiments of the present disclosure. The method of FIG. 4 includes determining 400 that a SHAS configuration has been loaded. Determining 400 that a SHAS configuration has been loaded maybe carried out by an operating system (such as operating system 103) based on an indication that the SHAS configuration has been loaded or responsive to calling 312 an API to load the SHAS configuration (see FIG. 3) and receiving a confirmation. The SHAS configuration, when loaded, indicates a list of device pairs configured for a storage high availability solution.

The method of FIG. 4 also includes, for each device pair indicated in the loaded SHAS configuration 402, determining 403 whether the device pair is in a Peer to Peer Remote Copy (PPRC) relationship and fully duplicated. Determining 403 whether the device pair is in a Peer to Peer Remote Copy (PPRC) relationship and fully duplicated may be carried out by an operating system (such as operating system 103) by performing a PPRC Query I/O to test the I/O devices.

The method of FIG. 4 also includes, for each device pair indicated in the SHAS configuration 402, indicating 404, if the device pair is not in a PPRC relationship or is not fully duplicated, that the device pair is not ready for the SHAS. Indicating 404 that the device pair is not ready for the SHAS may be carried out by an operating system (such as operating system 103) responsive to determining 403 that the device pair is not in a PPRC relationship or is not fully duplicated. The determination 403 (and any subsequent indication 404) is made for each device pair and then ends 405 and moves on to the next device pair indicated in the SHAS configuration. The determinations 403 and indications 404 for each device pair may be made subsequently or simultaneously.

The method of FIG. 4 also includes determining 406 whether there are any device pairs indicated as not ready. Determining 406 whether there are any device pairs indicated as not ready may be carried out by an operating system (such as operating system 103) after the determination 403 and subsequent indications 404 have been made for every device pair in the SHAS configuration. If there are any devices indicated as not ready, the method of FIG. 4 goes back to step 402 and continues checking the devices pairs until all of them are ready. In one embodiment, an indication of a device pair being not ready causes the operating system to delay enabling the storage high availability solution until all device pairs are in a PPRC relationship and are fully duplicated. In one embodiment, the operating system uses a brief delay before rechecking the device pairs (at step 402). In one embodiment, the delay includes waiting for a State Change Interrupt to be presented for the impacted to know when the PPRC state has changed. Device pairs that previously had an indication as being not ready that are subsequently checked again for a PPRC relationship and full duplication will have the indication (of not ready) removed once the device pairs are in PPRC and fully duplicated.

The method of FIG. 4 also includes enabling 408, once all of the device pairs in the SHAS configuration are ready, the SHAS. Enabling 408 the SHAS may be carried out by an operating system (such as operating system 103) by turning on the functions of SHAS and allowing for failover operations (associated with the SHAS) to be performed when needed. The SHAS configuration may then operate, including perform its standard monitoring, and can react to unplanned events. For example, if an unplanned SHAS event occurs, the system performs normal SHAS processing, including freezing device pairs, quiescing I/O, swapping UCBs, and resuming I/O. After the swap, the operating system is configured to reverse the direction of the device pair list (so that the primary and secondary are swapped for the device pair), and reloads the SHAS configuration in the new direction.

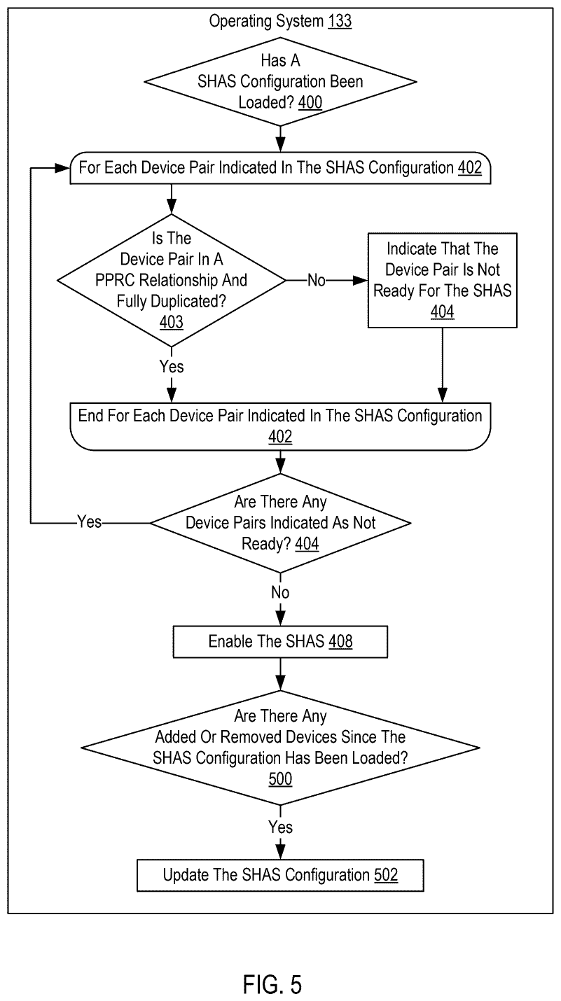

For further explanation, FIG. 5 sets forth a flow chart illustrating another exemplary method of automatically creating and loading a storage high availability solution configuration according to embodiments of the present disclosure. The method of FIG. 5 differs from the method of FIG. 4 in that the method of FIG. 5 further includes determining whether there are any newly added or removed devices since the SHAS configuration has been loaded. Determining 500 whether there are any newly added or removed devices since the SHAS configuration has been loaded may be carried out by an operating system (such as operating system 103) by checking for notifications indicating that one or more devices have been removed or newly added. In one embodiment, determining 500 includes receiving, by the operating system, a notification indicating one or more newly available devices. Such a notification may be received through Channel Report Words (CRWs) for the resources being added, prompting the operating system to check if the newly added devices are primaries that have special secondary pairs. In such an embodiment, the operating system is configured to indicate, based on whether the one or more newly available devices is a primary device that has a secondary pair, which of the one or more newly available devices will be added to the SHAS configuration. For example, if one of the newly available devices is part of a device pair and has a secondary pair, the device will be flagged with an indication that the device will be added to the SHAS configuration. When newly available devices are added, the replication manager server 150 is called to begin the PPRC mirroring for the devices before they are added to the SHAS configuration. Adding devices involves creating new subchannels within the hardware configuration, and UCBs within the SHAS configuration, which may be handled by a Dynamic Partition Manager (DPM). The operating system is configured to add the devices in the order of secondary devices first, followed by primary devices, so that it can easily track if a primary device has special secondary pairs.

The method of FIG. 5 also includes updating 502 the SHAS configuration. Updating 502 the SHAS configuration may be carried out by an operating system (such as operating system 103) by adding or removing devices from the SHAS configuration. Continuing with the above example, updating the SHAS configuration includes adding the indicated one or more newly available devices to the SHAS configuration. In one embodiment, updating the SHAS configuration includes purging the SHAS configuration and reloading an updated SHAS configuration (having the newly available devices added to it). In another embodiment, updating the SHAS configuration includes validating and adding the indicated one or more newly available devices to the SHAS configuration that is already loaded (without purging and reloading the SHAS configuration). In such an example embodiment, the operating system is configured to prevent the indicated one or more newly available devices from running (through VARY device code) until after they are added to the SHAS configuration. By waiting to run the PPRC managed devices until they are added to the configuration, the devices will be only permitted to run once they are backed up and available with the SHAS, which aids in device security. In one embodiment, where updating the SHAS configuration includes adding one or more newly available devices to the SHAS configuration (where the devices are device pairs with a primary device and a secondary device), the operating system is configured to add the secondary device to the SHAS configuration before the primary device. By adding the secondary device to the SHAS configuration first, the primary device is not added without already having a secondary pair in place within the configuration, further guaranteeing device duplication and security.

In another example embodiment, determining 500 includes receiving, by the operating system, a notification indicating one or more removed devices. Such a notification may be received through Channel Report Words (CRWs) for the resources being removed, prompting the operating system to check if the removed devices were included in the SHAS configuration. In such an embodiment, the operating system is configured to indicate, based on whether the one or more removed devices is included in the SHAS configuration, which of the one or more removed devices will be removed from the SHAS configuration. For example, if one of the removed devices was included in the SHAS configuration, the device will be flagged with an indication that the device will be removed from the SHAS configuration. Continuing with such an example embodiment, updating 502 the SHAS configuration includes removing the indicated one or more removed devices from the SHAS configuration. In one embodiment, updating the SHAS configuration includes purging the SHAS configuration and reloading an updated SHAS configuration (no longer having the removed devices). In another embodiment, updating the SHAS configuration includes validating and removing the indicated one or more removed devices from the SHAS configuration that is already loaded (without purging and reloading the SHAS configuration).

In view of the explanations set forth above, readers will recognize that the benefits of automatically creating and loading a storage high availability solution configuration according to embodiments of the present disclosure include:
Increasing customer privacy and security by having storage high availability with failover protection without allowing the replication manager to communicate with the customer data plane.
Increasing system efficiency by having the operating system build and manage the SHAS configuration without relying on the management plane.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of creating and loading a storage high availability solution configuration, the method comprising:
starting, by an operating system, a storage high availability solution address space;
for each device coupled to the operating system, determining whether the device is part of a device pair as a primary device that has a secondary pair and, if so, adding the device to a list of devices configured for a storage high availability solution, wherein the list of devices is included in a storage high availability solution configuration; and
loading, by the operating system and based on the list of devices including at least one device, the storage high availability solution configuration.

2. The method of claim 1, wherein a device configured with the storage high availability solution is configured to be included in a failover swapping operation.

3. The method of claim 2, wherein performing the failover swapping operation includes swapping from the primary device to the secondary pair.

4. The method of claim 1, wherein loading the storage high availability solution configuration includes:
building a control block comprising each device pair included in the list of devices, wherein the control block is included in the storage high availability solution configuration;
indicating that the storage high availability solution configuration is not yet ready for enabling; and
calling an application programming interface (API) to load the storage high availability solution configuration.

5. A method of running a storage high availability solution configuration, the method comprising:
determining, by an operating system, that a storage high availability solution configuration has been loaded, wherein the storage high availability solution configuration indicates a list of device pairs configured for a storage high availability solution;
for each device pair indicated in the storage high availability solution configuration:
determining whether the device pair is in a Peer to Peer Remote Copy (PPRC) relationship and fully duplicated; and
indicating, if the device pair is not in a PPRC relationship or is not fully duplicated, that the device pair is not ready for the storage high availability solution; and
responsive to determining that none of the device pairs indicated in the storage high availability solution configuration are indicated as not ready, enabling the storage high availability solution.

6. The method of claim 5, wherein an indication of a device pair being not ready causes the operating system to delay enabling the storage high availability solution until all device pairs are in a PPRC relationship and are fully duplicated.

7. The method of claim 5, further comprising adding devices to the storage high availability solution configuration, including:
receiving, by the operating system, a notification indicating one or more newly available devices;
indicating, based on whether the one or more newly available devices is a primary device that has a secondary pair, which of the one or more newly available devices will be added to the storage high availability solution configuration; and
updating the storage high availability solution configuration, including adding the indicated one or more newly available devices to the storage high availability solution configuration.

8. The method of claim 7, wherein updating the storage high availability solution configuration includes:
purging the storage high availability solution configuration; and
reloading an updated storage high availability solution configuration.

9. The method of claim 7, wherein updating the storage high availability solution configuration includes validating and adding the indicated one or more newly available devices to the storage high availability solution configuration that is already loaded.

10. The method of claim 7, wherein the operating system is configured to prevent the indicated one or more newly available devices from running until they are added to the storage high availability solution configuration.

11. The method of claim 7, wherein the one or more newly available devices are device pairs with a primary device and a secondary device, wherein the secondary device is added before the primary device.

12. The method of claim 5, further comprising removing devices from the storage high availability solution configuration, including:
receiving, by the operating system, a notification indicating one or more removed devices;
indicating, based on whether the one or more removed devices is included in the storage high availability solution configuration, which of the one or more removed devices will be removed from the storage high availability solution configuration; and
updating the storage high availability solution configuration, including removing the indicated one or more removed devices from the storage high availability solution configuration.

13. The method of claim 12, wherein updating the storage high availability solution configuration includes:
purging the storage high availability solution configuration; and
reloading an updated storage high availability solution configuration.

14. The method of claim 12, wherein updating the storage high availability solution configuration includes validating and removing the one or more removed devices from the storage high availability solution configuration that is already loaded.

15. A system comprising:
a replication manager server;
a group of computing systems, wherein each computing system comprises an operating system;
a first volume group communicatively coupled to the group of computing systems, wherein the first volume group comprises multiple volumes; and
a second volume group communicatively coupled to the group of computing systems and separate from the first volume group, wherein the second volume group is a copy of the first volume group.

16. The system of claim 15, further comprising a third volume group communicatively coupled to the group of computing systems and separate from the first volume group and the second volume group, wherein the third volume group is another copy of the first volume group for replication redundancy.

17. The system of claim 15, wherein each of the first volume group and the second volume group is located at a different physical site.

18. The system of claim 15, wherein each of the first volume group and the second volume group include system volumes, customer data volumes, and cross system coupling facility (XCF) managed couple dataset volumes.

19. The system of claim 15, wherein each volume within each volume group indicates whether it is configured with a storage high availability solution.

20. The system of claim 15, wherein the replication manager server is configured to communicate with a storage array manager associated with each of the first and second volume groups but is not configured to communicate with the group of computing systems and the first and second volume groups.
